(19) United States
(12) Patent Application Publication
(10) Pub. No.: US 2009/0035622 A1
(43) Pub. Date: Feb. 5, 2009

(54) SYSTEMS AND METHODS FOR REDUCING ORGANIC SULFUR COMPONENTS IN HYDROCARBON FUELS

(75) Inventors: David L. King, Richland, WA (US); Xiwen Huang, Pasco, WA (US); Feng Zheng, Richland, WA (US); Victoria S. Stenkamp, Richland, WA (US); Ward E. Tegrotenhuis, Kennewick, WA (US); Dale A. King, Pasco, WA (US); Greg A. Whyatt, West Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute

(21) Appl. No.: 12/182,640

(22) Filed: Jul. 30, 2008

Related U.S. Application Data
(60) Provisional application No. 60/953,138, filed on Jul. 31, 2007.

(51) Int. Cl. H01M 8/04; C10G 45/00; H01M 8/18

(52) U.S. Cl. 429/17; 208/214; 208/211; 208/212; 429/19

(57) ABSTRACT

The present invention includes systems and methods of treating a hydrocarbon fuel to reduce organic sulfur components so as to be amenable to small-scale and/or field-based applications. Embodiments of the invention involve the performance of a vapor-phase hydrodesulfurization operation using steam reformate. The steam reformate is a hydrogen source for the hydrodesulfurization and is provided by an integrated steam reformer.

### PRIORITY

This invention claims priority from provisional patent application No. 60/953,138, entitled Steam Reformate Initiated Hydrodesulfurization of JP-8 Fuel and its Light Fractions, filed Jul. 31, 2007, which is incorporated herein by reference.

### STATEMENT REGARDING FEDERALLY SPONSORED RESEARCH OR DEVELOPMENT

This invention was made with United States Government support under Contract W56 HZV-06-C-0343 awarded to Battelle Memorial Institute. The Government has certain rights in this invention.

### BACKGROUND

In the field of hydrocarbon fuel processing, a need exists for efficient ways to reduce organic sulfur components. Current technologies for removing sulfur from liquid hydrocarbon feedstocks can include hydrodesulfurization (HDS). In HDS, the organic sulfur in the fuel is catalytically converted to H₂S. Such a conversion typically occurs under high hydrogen pressures. The high temperature and pressure requirements of current HDS technology makes it difficult to adapt to small-scale applications. As a result, for compact implementations, sulfur removal technologies based primarily on adsorption have gained in popularity. However, adsorptive desulfurization approaches can be difficult to adapt for applications in which the units are field deployed because of the maintenance requirements associated with adsorbent regeneration and a typical lack of adsorbent stability through many cycles.

One example of the need for new desulfurization approaches involves field-based power generation. One promising technology is fuels cells, which can provide a silent, portable source of power having a low heat signature. However, fuel cells require hydrogen as fuel. Short of providing stored hydrogen gas, the primary means of supplying hydrogen is by reforming a hydrocarbon fuel. One major barrier to hydrocarbon reformation can be the presence of significant organic sulfur impurities, which can poison the catalysts in the reformer and the electrode catalysts in the fuel cell.

The present invention provides a hydrsodesulfurization process that is compatible with small-scale and/or field-based applications and avoids many of the disadvantages of current approaches.

### SUMMARY

The present invention includes systems and methods of treating a hydrocarbon fuel to reduce organic sulfur components so as to be amenable to small-scale and/or field-based applications. Embodiments of the invention involve the performance of a vapor-phase hydrodesulfurization operation using steam reformate. The steam reformate is a hydrogen source for the hydrodesulfurization and is provided by an integrated steam reformer. Operation in the vapor phase allows for a reduction in the total operating pressure for compatibility with the steam reformer and also to eliminate the need for large and/or heavy equipment associated with high temperate or high pressure operation compared to other existing devices and methods. The use of steam reformate as a hydrogen source for HDS is advantageous for field-based applications, where hydrogen gas is likely to be unavailable. In the interest of process and system simplicity, preferred implementations utilize steam reformate that is not dried to remove water. Exemplary materials for catalyzing the vapor-phase HDS can include, but are not limited to, CoMo/Al₂O₃, Ni—W/Al₂O₃, or NiMo/Al₂O₃ catalysts.

In some embodiments various unit processes can be introduced to enhance performance and/or increase functionality. For example, the hydrocarbon fuel can be distilled such that the vapor-phase hydrodesulfurization is performed on a light fraction of the hydrocarbon fuel. In particular, the distillation can comprise microchannel distillation. However, as used herein, distillation does not refer to flash distillation.

After performing hydrodesulfurization, the hydrocarbon fuel can optionally be adsorbent polished. While adsorbent polishing can be used to remove the final traces of sulfur, the present invention does not rely primarily on an adsorbent approach.

In yet another example, the steam reformate can be provided to a fuel cell as a low-sulfur hydrogen source.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a diagram depicting the unit processes for treating a hydrocarbon fuel to reduce organic sulfur according to embodiments of the present invention.

FIG. 2 is a diagram depicting aspects of one embodiment of a microchannel distillation system.

FIG. 3 is a plot of the product sulfur concentration as a function of time while treating JP-8 fuel according to embodiments of the present invention. FIG. 4 contains chromatograms of full JP-8 fuel before and after treatment according to embodiments of the present invention.

FIG. 5 is a plot summarizing the impact of the presence steam on product sulfur concentration.

FIG. 6 is a plot of product sulfur concentration after treatment of road diesel samples under a variety of process conditions consistent with embodiments of the present invention.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, It should be understood, that there is no intention to limit the invention to the specific form disclosed, but, on the contrary, the invention is to cover all modifications, alternative constructions, and equivalents falling within the spirit and scope of the invention as defined in the claims.

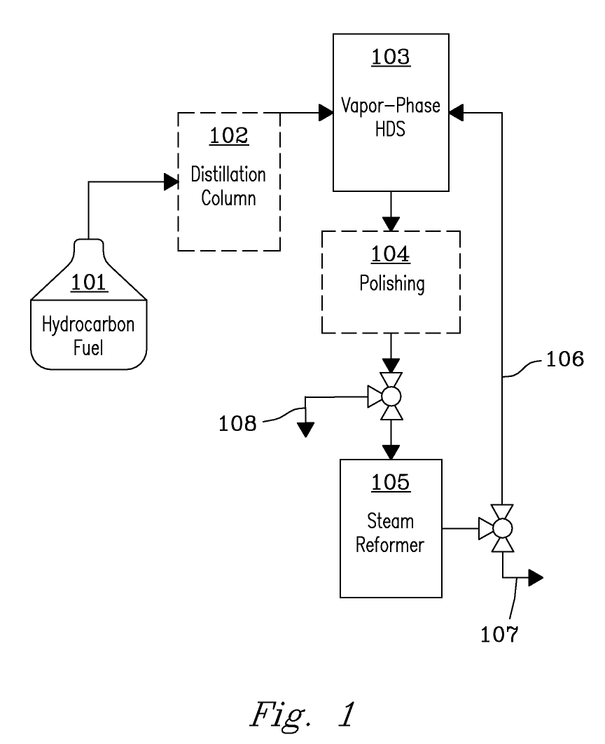

FIGS. 1-6 show a variety of embodiments and/or aspects of the present invention. Referring first to FIG. 1, a diagram is shown depicting the treatment of a hydrocarbon fuel to reduce organic sulfur components according to one embodiment. The unit processes include an integrated vapor-phase hydrodesulfurization (HDS) unit 103 and a steam reformer 105. Hydrocarbon fuel 101 reacts in the vapor-phase HDS unit 103 with a portion of the steam reformate 106, which serves as a hydrogen source. Unreacted steam reformate, after HDS, would likely contain H₂S and can be separated from the desulfurized hydrocarbon fuel. The H₂S-containing unreacted steam reformate can, for example, be combusted to provide heat to maintain the endothermic steam reforming reaction and/or the HDS reaction. The desulfurized hydrocarbon fuel is then fed to the steam reformer 105. A portion of the desulfurized hydrocarbon fuel 108 can also be taken as a desired product or can be directed to additional unit processes for further processing. In a preferred embodiment, a portion of the steam reformate 107 is taken as the final product and can be used as a source of hydrogen.

Optionally, embodiments of the present invention can include distillation 102 and/or polishing unit processes 104. While it is not necessary, distilling the hydrocarbon fuel prior to hydrodesulfurization can facilitate operation in the vapor phase. For example, the light boiling fraction of the hydrocarbon fuel is more readily vaporized, thereby relaxing the requirements for high-pressure and/or high-temperature equipment. Distillation can further reduce the catalytic burden of the HDS unit by removing the heavy, high-boiling sulfur compounds.

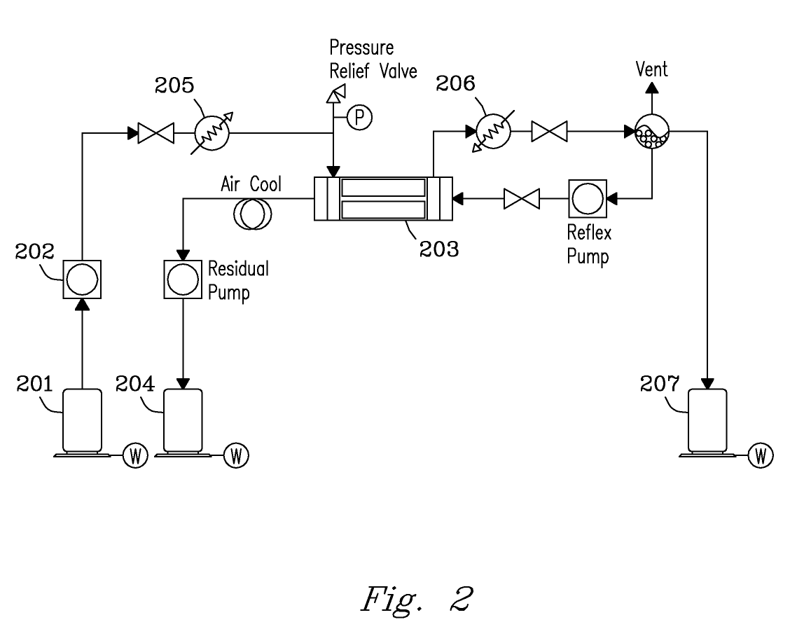

In preferred embodiments, the distillation unit is a microchannel distillation system. Referring to FIG. 2, a schematic drawing depicts one example of a suitable microchannel distillation unit 200 being used as a rectifier. Briefly, the unit comprises a feed pump 202 to draw the hydrocarbon fuel 201 to a preheater 205 and then to the channel device. The vapor product is removed from the opposite end of the channel device and condensed by a condenser 206 as the distillate product 207. A portion of the condensate is refluxed back to the channel device as a liquid feed. A heavy fraction liquid is removed from the feed end as the residual product 204. The microchannel distillation device 203 is oriented in such a way that all internal vapor and liquid flow horizontally. The microchannel distillation process of the present embodiment is based on microwicks. Liquid hydrocarbon is pumped through thin wicks that have a thickness in the range of 0.1-1 mm. Vapor flows counter-current to the liquid flow. The thinness of the wicks facilitates rapid heat and mass transfer between the vapor and liquid phases, resulting in intensification of the process. The device is easily scalable by adding or removing channels.

### EXAMPLE

### HDS of JP-8 Light Fraction Using Steam Reformate

Raw JP-8 fuel having 1400 ppmw was processed according to embodiments of the present invention to reduce the amount of organic sulfur. The catalysts employed for HDS included presulfided CoMo/Al₂O₃ and/or NiMo/Al₂O₃, though other suitable catalysts can be utilized and still fall within the scope of the present invention. For a typical run, the catalyst was loaded into the HDS reactor and pretreated for 4 h with a mixture comprising 75 sccm H₂ and 4 cm³/hr of a JP-8 light cut at 343° C. and 250 psig. The light-cut JP-8 was prepared by glassware distillation with a cutoff temperature of 176° C. The distillation cut was chosen to eliminate the less reactive, heavy sulfur compounds such as benzothiophene (BT) and alkyl-substituted BT. Simulated syngas comprising 74% H₂, 12% CO₂, and 12% CO was supplied, which represents a typical steam reformate composition after reforming various liquid hydrocarbons. This reformate typically included approximately 40 vol % steam based on an initial H₂O/carbon feed ratio of 3.

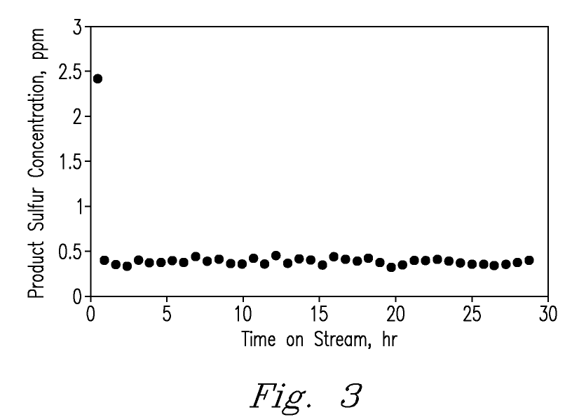

The HDS reaction was carried out in a fixed bed reactor with a 1-2 g catalyst loading. Simulated dry reformate and JP-8 light cut were introduced to the HDS reactor at 350-400° C. after being mixed in a microchannel vaporizer. The HDS reaction was carried out near-isothermally, with reaction pressures ranging from 50 psi to 280 psig. The distillation curve of the raw JP-8 was simulated by CHEMCAD, and the results were used to provide an operating window to ensure the fuel remained in the gas phase under all conditions of operation. Liquid product was collected upstream of a backpressure regulator in a pressure vessel held at 4° C. Referring to FIG. 3, a plot of the product sulfur concentration (ppm) as a function of time indicates that steady-state operation can be achieved after approximately one hour on-stream with the final product sulfur content being reduced to levels below approximately 0.5 ppm.

Referring to FIG. 4, chromatograms of full JP-8 fuel 400 and JP-8 fuel after HDS processing 401 indicate that the methods and systems described herein can successfully be applied to JP-8 without distillation. The full JP-8 contained approximately 1225 ppm of sulfur in various compounds including 2, 3-DMBT, 2, 3, 7-TMBT, and 2, 3, 5-TMBT. After HDS processing according to embodiments of the present invention, the sulfur concentration decreased to 4.6 ppm. Additional sulfur removal can achieved through process optimization and/or the use of distillation and/or sulfur polishing. However, surprisingly, the sulfur removal task can be handled by HDS using steam reformate without pretreating the hydrocarbon fuel by distillation.

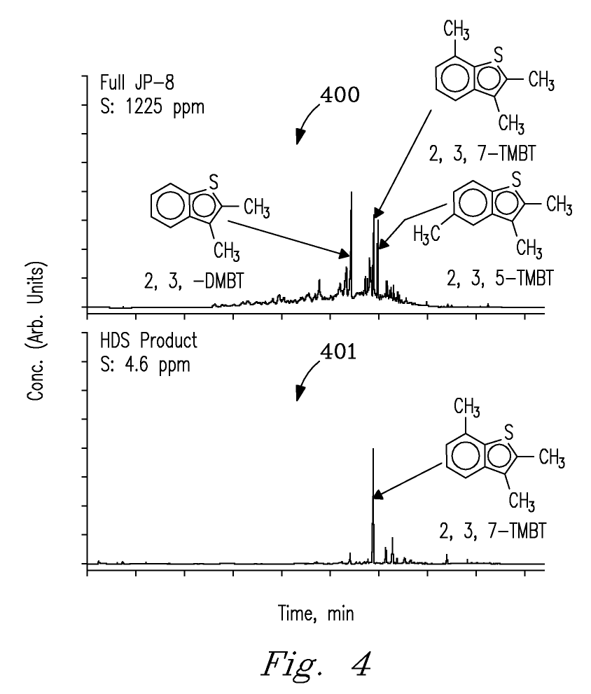

Referring to FIG. 5, a plot of product sulfur content after HDS of full JP-8 as a function of water content in the steam reformate indicates that the impact of steam on sulfur conversion is small and occurs primarily at high steam concentrations (e.g., greater than 40%). Accordingly, it is not necessary to dry the steam reformate prior to reacting the reformate with the hydrocarbon fuel in the HDS unit. In preferred embodiments, the steam reformate is not dried to remove water, thereby reducing equipment requirements and improving efficiency.

### EXAMPLE

### HDS of Road Diesel Using Steam Reformate

Low-sulfur road diesel having approximately 4 ppmw was processed according to embodiments of the present invention and similar to the manner described in the previous example. While a variety of operating conditions were utilized and can be appropriate, representative conditions are described as follows. The catalysts for HDS comprised NiMo/Al₂O₃. HDS was performed at a temperature of 365° C. and a pressure of 270 psig.

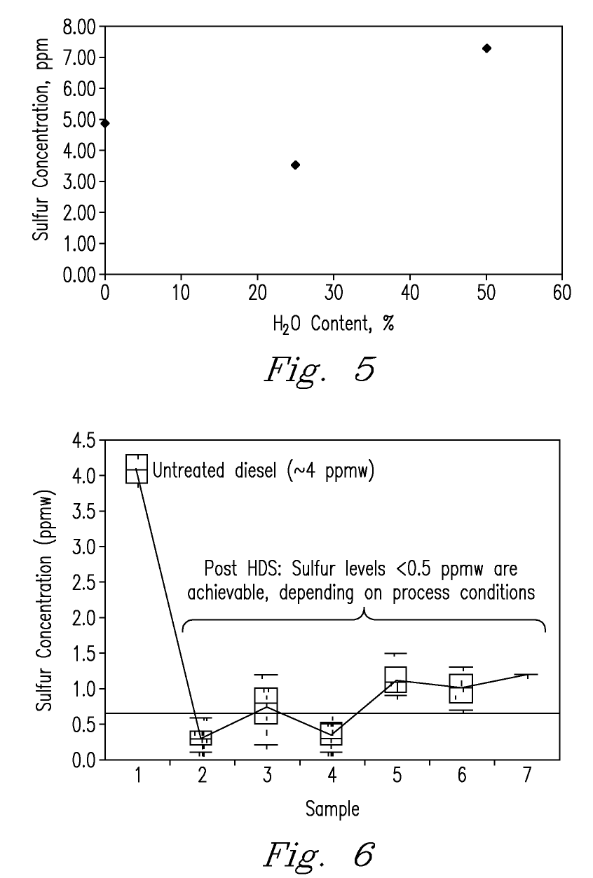

Referring to FIG. 6, a plot of the sulfur content in the untreated and treated diesel is shown for various samples. The plot indicates that as is the case for JP-8, vapor-phase hydrodesulfurization using steam reformate is an effective treatment for reducing the organic sulfur content in road diesel. With treatment that is consistent with embodiments of the present invention, sulfur levels could be commonly decreased to less than 0.5 ppmw.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method of treating a hydrocarbon fuel to reduce organic sulfur components, the method comprising performing vapor-phase hydrodesulfurization using steam reformate from an integrated steam reformer as a hydrogen source.

2. The method of claim 1, wherein the steam reformate is not dried to remove water.

3. The method of claim 1, wherein the vapor-phase hydrodesulfurization is performed over a CoMo/Al₂O₃, Ni—W/Al₂O₃, or NiMo/Al₂O₃ catalyst.

4. The method of claim 1, further comprising distilling the hydrocarbon fuel and performing the vapor-phase hydrodesulfurization on a light fraction of the hydrocarbon fuel.

5. The method of claim 1, wherein said performing vapor-phase hydrodesulfurization comprises operating at a pressure below 280 psi.

6. The method of claim 1, further comprising adsorbent polishing of the hydrocarbon fuel after performing hydrodesulfurization.

7. The method of claim 1, further comprising providing to a fuel cell a portion of the steam reformate as a low-sulfur hydrogen source.

8. A system for treating a hydrocarbon fuel to reduce organic sulfur components, the system comprising a compact vapor-phase hydrodesulfurization unit receiving from an integrated steam reformer steam reformate as a hydrogen source.

9. The system of claim 8, wherein the steam reformate is not dried to remove water.

10. The system of claim 8, wherein the vapor-phase hydrodesulfurization unit comprises a CoMo/Al₂O₃, Ni—W/Al₂O₃, or NiMo/Al₂O₃ catalyst.

11. The system of claim 8, further comprising a distillation unit arranged to provide a light fraction of the hydrocarbon fuel to the vapor-phase hydrodesulfurization unit, wherein the distillation unit is not a flash distillation unit.

12. The system of claim 8, wherein the vapor-phase distillation unit operates at a pressure below 280 psi.

13. The system of claim 8, further comprising an adsorbent polishing unit arranged to polish the output of the vapor-phase hydrodesulfurization unit.

14. The system of claim 8, further comprising a fuel cell arranged to receive a portion of the steam reformate as a low-sulfur hydrogen source.
